(19) United States
(12) Patent Application Publication
(10) Pub. No.: US 2008/0065704 A1
(43) Pub. Date: Mar. 13, 2008

(54) Data and replica placement using r-out-of-k hash functions

(75) Inventors: John Philip MacCormick, San Francisco, CA (US); Nicholas Murphy, San Mateo, CA (US); Venugopalan Ramasubramanian, Mountain View, CA (US); Ehud Wieder, Sunnyvale, CA (US); Lidong Zhou, Sunnyvale, CA (US); Junfeng Yang, Stanford, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/519,538

(22) Filed: Sep. 12, 2006

(51) Int. Cl. G06F 17/30

(52) U.S. Cl. 707/204

(57) ABSTRACT

A distributed data store employs replica placement techniques in which a number k hash functions are used to compute k potential locations for a data item. A number r of the k locations are chosen for storing replicas. These replica placement techniques provide a system designer with the freedom to choose r from k, are structured in that they are determined by a straightforward functional form, and are diffuse such that the replicas of the items on one server are scattered over many other servers. The resulting storage system exhibits excellent storage balance and request load balance in the presence of incremental system expansions, server failures, and load changes. Data items may be created, read, and updated or otherwise modified.

### BACKGROUND

Distributed storage systems have become increasingly important for running information technology services. The design of such distributed systems, which consist of several server machines with local disk storage, involves a trade off between three qualities: (i) performance (serve the workload responsively); (ii) scalability (handle increases in workload); and (iii) availability and reliability (serve workload continuously without losing data). Achieving these goals requires adequately provisioning the system with sufficient storage space and network bandwidth, incrementally adding new storage servers when workload exceeds current capacity, and tolerating failures without disruption of service.

The prior art has typically resorted to over provisioning in order to achieve the above properties. However, increasing costs in hosting a distributed storage system, for hardware purchases, power consumption, and administration, mean that over provisioning is not a viable option in the long run. The ability to achieve requisite quality of service with fewer resources translates to a large savings in total monetary cost. But balanced use of resources is crucial to avoid over-provisioning. If the system has high utilization but poor balance, the disk or network resources of some part of the system will cause an unnecessary bottleneck, leading to bad performance or possibly complete stagnation.

### SUMMARY

A distributed data store employs replica placement techniques in which a number k of hash functions are used to compute that same number of potential locations for a data item and a subset r of these locations are chosen for storing replicas. These replica placement techniques provide a system designer with the freedom to choose r from k, are structured in that they are determined by a straightforward functional form, and are diffuse such that the replicas of the items on one server are scattered over many other servers. The resulting storage system exhibits excellent storage balance and request load balance in the presence of incremental system expansions, server failures, and load changes.

A distributed storage system has a large number of servers and a large number of data items to be stored on the servers. The set of servers is divided into k groups and k hash functions are employed. The number k may be chosen based on the desired level of redundancy and replication. The data store is parameterized by a number k of hash functions. The k locations are based on the multiple hash functions. A replication factor r is chosen, where r<k. A new data item is received and is hashed to k possible locations. The item is stored on the r servers among these locations, with the most spare storage capacity. Therefore, r locations of the k locations are chosen based on the least utilized servers in k. Data items may be created, read, and updated or otherwise modified.

When servers fail, the number of remaining replicas for certain data items falls below r. Fast restoration of the redundancy level is crucial to reducing the probability of data loss. Because k>r holds, unused hash locations exist. The failed replicas may be recreated at those unused hash locations to preserve the invariant that all replicas of a data item are placed at its hash locations, thereby eliminating the need for any bookkeeping or for consistent meta-data updates.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram describing an initial setting of a system.

FIG. 2 is a flow diagram of an example storage balancing method.

FIG. 3 is a diagram of an example distributed storage system.

FIG. 4 is a flow diagram of an example server mapping method.

FIG. 5 is a diagram useful in describing an example involving the addition of servers to a distributed storage system.

FIGS. 6 and 7 are diagrams useful in describing an example of replication to tolerate failures.

FIG. 8 is a flow diagram of an example method of replication to tolerate failures.

FIG. 9 is a flow diagram of an example method of balancing network bandwidth during the creation or writing of a received data item on a number of servers.

FIG. 10 is a flow diagram of an example method of reading a data item, while maintaining network bandwith balancing.

FIG. 11 is a flow diagram of an example method of balancing network bandwidth during the updating of a received data item on a number of servers.

FIG. 12 is a block diagram of an example computing environment in which example embodiments and aspects may be implemented.

### DETAILED DESCRIPTION

A distributed data store employs replica placement techniques in which a number k of hash functions are used to compute that same number of potential locations for a data item and a subset r of these locations are chosen for storing replicas. These replica placement techniques provide a system designer with the freedom to choose r from k, are structured in that they are determined by a straightforward functional form, and are diffuse such that the replicas of the items on one server are scattered over many other servers. The resulting storage system exhibits excellent storage balance and request load balance in the presence of incremental system expansions, server failures, and load changes. Fast parallel recovery is also facilitated. These benefits translate into savings in server provisioning, higher system availability, and better user-perceived performance.

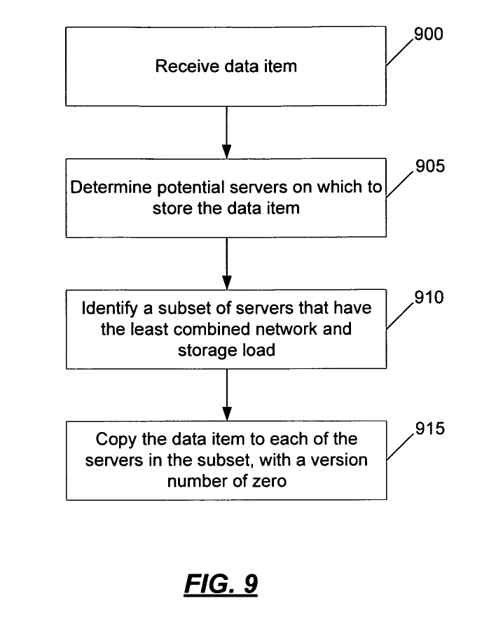

Techniques are provided for placing and accessing items in a distributed storage system that satisfy the desired goals with efficient resource utilization. Having multiple choices for placing data items and replicas in the storage system is combined with load balancing algorithms, leading to efficient use of resources. After the server architecture is created, and the k potential locations for a data item are determined along with the r locations for storing replicas, data items may be created, read, and updated, and network load may be balanced in the presence of both reads and writes. Create, update, and read operations pertaining to data items are described herein, e.g., with respect to FIGS. 9-11.

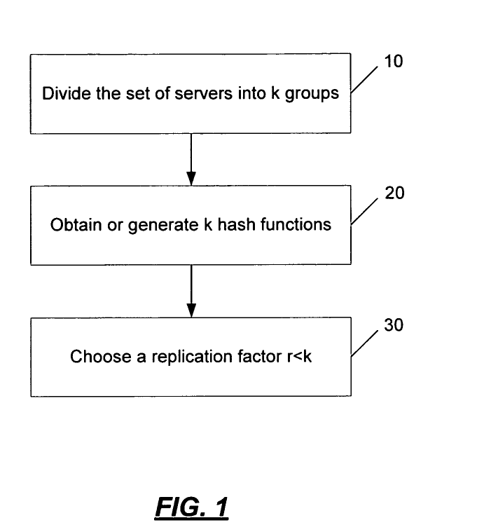

FIG. 1 is a flow diagram describing an initial setting of a system. A distributed storage system has a large number of servers and a large number of data items to be stored on the servers. At step 10, the set of servers is divided into k groups and k hash functions are obtained or generated. k may be chosen based on the desired level of redundancy and replication, as described further herein. Thus, the data store is parameterized by a number k of hash functions (e.g., k=5). The k locations are based on the multiple (i.e., k) hash functions.

At step 20, k hash functions are generated or obtained, one for each set of servers. At step 30, a replication factor r is chosen, where r<k.

Thus, the servers are divided into k groups where servers in different groups do not share network switches, power supply etc. A separate hash function for each group maps a data item to a unique server in that group. Any data item is stored at r of k possible servers. The parameters k and r are not picked every time a data item arrives, but instead are determined ahead of time in the design of the server architecture and organization.

The choice of k and r significantly influences the behavior of the system. In practice, r is chosen based on the reliability requirement on the data. A larger r provides better fault tolerance and offers potentials for better query load balancing (due to the increase in the number of choices), but with higher overhead. In typical scenarios, r is chosen between 3 and 5.

The gap between k and r decides the level of freedom. The larger the gap, the more freedom the scheme has. This translates into better storage balancing and to fast re-balancing after incremental expansion. A larger gap also offers more choices of locations on which new replicas can be created when servers fail. In particular, even with k-r failures among k hash locations, there still exist r hash locations to store the replicas. However, a larger k with a fixed r incurs a higher cost of finding which hash locations have the data item: without the cache on the front-end for the mapping from data items to their locations, k hash locations are probed.

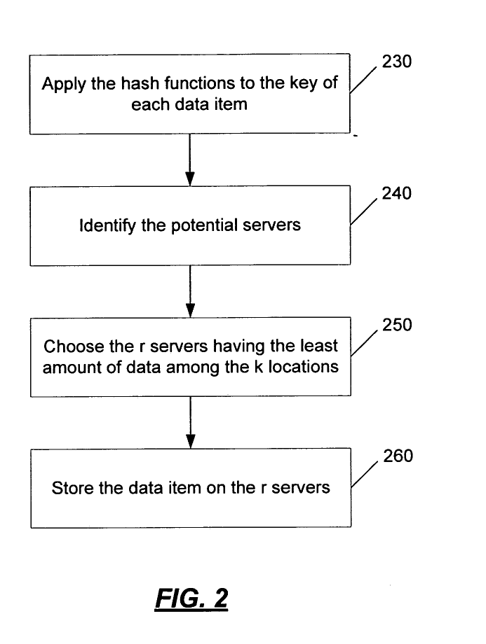

More particularly, regarding storage balancing described with respect to the flow diagram of FIG. 2, each data item has a key, on which the hash functions are applied at step 230. Hash function hᵢ maps a key to a server in segment i. Therefore, a data item with key d has k distinct potential server locations: {hᵢ(d) |1≦i≦k} at step 240. These are the hash locations for the data item. A number of servers r are chosen with the least amount of data among those k hash locations at step 250. The item is stored on the r servers at step 260.

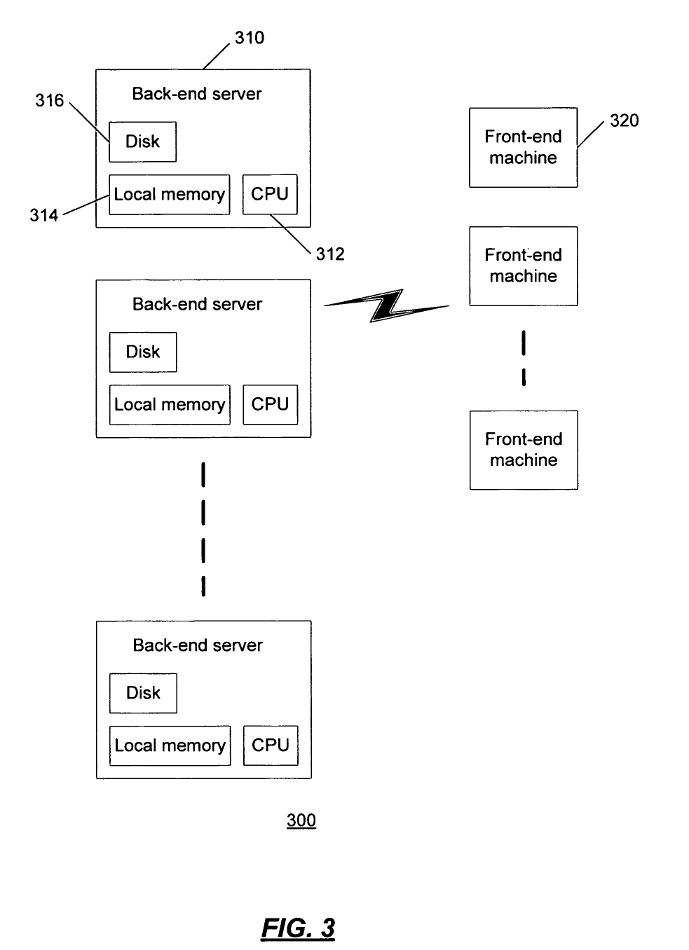

In a typical setting, as shown in FIG. 3 for example, the system 300 has a large number of back-end server machines 310 for storage of data items. Each server has one or more CPUs 312, local memory 314, and locally attached disks 316. There are also one or more front-end machines 320 that take client requests and distribute the requests to the back-end servers 310. All these machines are in the same administrative domain, connected through one or multiple high-speed network switches. The servers are often organized into racks with their own shared power supply and network switches. Correlated failures are more likely within such a rack than across racks.

New machines may be added to the system from time to time for incremental expansion. Assume that new servers are added to the segments in a round-robin fashion so that the sizes of segments remain approximately the same. A hash function for a segment accommodates the addition of new servers so that some data items are mapped to those servers. Any dynamic hashing technique may be used. For example, linear hashing may be used within each segment for this purpose.

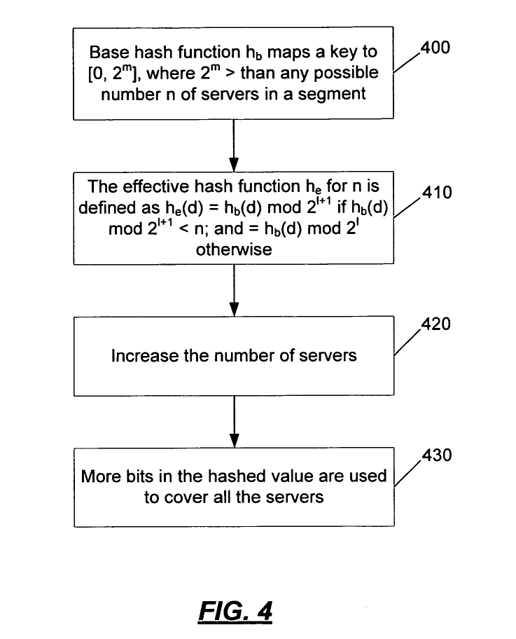

A fixed base hash function is distinguished from an effective hash function. The effective hash function relies on the base hash function, but changes with the number of servers to be mapped to. For example, as described with respect to the diagram of FIG. 4, a base hash function h_{b} maps a key to [0, 2^{m}], at step 400, where 2^{m} is larger than any possible number n of servers in a segment. More accurately, the base hash function would be denoted h_{b,i} because it is specific to the ith segment. The extra subscript is omitted for readability. This also applies to hₑ. For simplicity, assume that the n servers in a segment are numbered from 0 to n-1. Let 1=log₂(n) (i.e., 2¹≦n<2¹⁺¹ holds). At step 410, the effective hash function hₑ for n is defined as hₑ(d)=h_{b}(d) mod 2¹⁺¹ if h_{b}(d) mod 2¹⁺¹<n; and =h_{b}(d) mod 2¹ otherwise.

The number of servers increases at step 420. At step 430, more bits in the hashed value are used to cover all the servers. For example, for cases where n=2¹ for some 1, the effective hash function is h_{b}(d) mod n for any key d. For 2¹<n<2¹⁺¹, the first and the last n-2¹ servers will use the lower 1+1 bits of the hashed value, while the remaining servers will use the lower 1 bits.

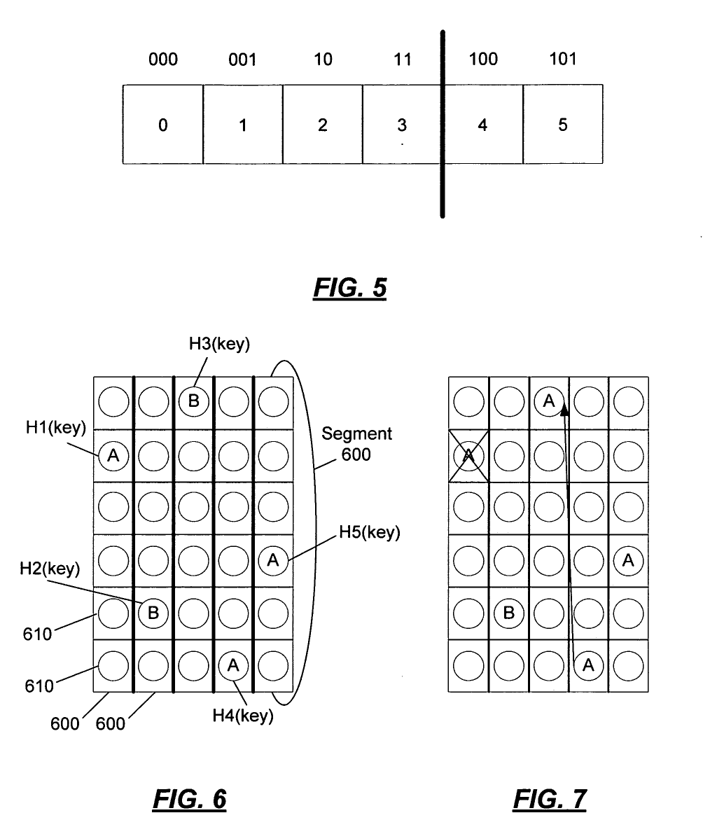

FIG. 5 illustrates an example in which additions of servers 4 and 5 leads to a split of servers 0 and 1. With four servers, only the last two bits of a hash value are used to determine which server to map to. With the addition of servers 4 and 5, the spaces allocated to servers 0 and 1 are split using the third-lowest bit: hash values that end with 100 are now mapped to server 4 instead of server 0, while hash values that end with 101 are mapped to server 5 instead server 1.

Note that servers 0, 1, 4, and 5 now each control only half the hash value space compared to that of server 2 or 3. This is generally true when 2¹<n<2¹⁺¹ holds. In other words, linear hashing inherently suffers from hash-space imbalance for most values of n. However, this may be corrected by favoring the choice of replica locations at less-utilized servers.

Regarding high performance, storage balance is achieved through the controlled freedom to choose less-utilized servers for the placement of new replicas. Request load balance is achieved by sending read requests to the least-loaded replica server. Because the replica layout is diffuse, excellent request load balance is achieved. Balanced use of storage and network resources ensures that the system provides high performance until all the nodes reach full capacity and delays the need for adding new resources.

Regarding scalability, incremental expansion is achieved by running k independent instances of linear hashing. This approach by itself may compromise balance, but the controlled freedom mitigates this. The structured nature of the replica location strategy, where data item locations are determined by a straightforward functional form, ensures that the system need not consistently maintain any large or complex data structures during expansions.

Regarding availability and reliability, basic replication ensures continuous availability of data items during failures. The effect of correlated failures is alleviated by using hash functions that have disjoint ranges. Servers mapped by distinct hash functions do not share network switches and power supply. Moreover, recovery after failures can be done in parallel due to the diffuse replica layout and results in rapid recovery with balanced resource consumption.

Replication is used to tolerate failures. Replicas are guaranteed to be on different segments, and segments are desirably designed or arranged so that intersegment failures have low correlation. Thus, data will not become unavailable due to typical causes of correlated failures, such as the failure of a rack's power supply or network switch.

When servers fail, the number of remaining replicas for certain data items falls below r. Fast restoration of the redundancy level is crucial to reducing the probability of data loss. Because k>r holds, unused hash locations exist. It is desirable to re-create the failed replicas at those unused hash locations to preserve the invariant that all replicas of a data item are placed at its hash locations, thereby eliminating the need for any bookkeeping or for consistent meta-data updates.

Due to the pseudo-random nature of the hash functions, as well as their independence, data items on a failed server are likely to have their remaining replicas and their unused hash locations spread across servers of the other segments. The other hash locations are by definition in other segments. This leads to fast parallel recovery that involves many different pairs of servers, which has been shown effective in reducing recovery time.

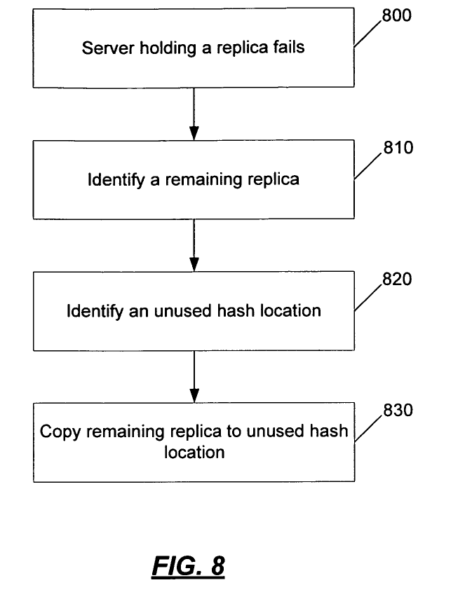

FIGS. 6 and 7 are diagrams useful in describing an example of replication to tolerate failures, and FIG. 8 is a corresponding flow diagram. Multiple segments 600 are shown, each containing one or more racks of servers 610. Each segment 600 is shown in FIG. 6 in the vertical direction. Assume that the servers marked “A” are hash locations that store replicas (the r replicas of the k locations) and the servers marked “B” are unused hash locations. When the server (H1(Key)) holding one replica fails (step 800), as shown by the “X” in FIG. 7, a remaining replica is identified (step 810) along with an unused hash location (step 820). A new replica is created on an unused hash location (H3(Key)) by copying from the server (H4(Key)) holding one of the remaining replicas (step 830).

New front-end machines may also be added during incremental expansion. Failed front-end machines should be replaced promptly. The amount of time it takes to introduce a new front-end machine depends mainly on the amount of state the new front-end must have before it can become functional. The state is desirably reduced to a bare minimum. Because the hash locations may be determined from the system configuration (including the number of segments and their membership), the front-end does not need to maintain a mapping from data items to servers: each back-end server maintains the truth of its inventory. Compared to storing an explicit map of the item locations, this greatly reduces the amount of state on the front-end, and removes any requirements for consistency on the front-ends. Moreover, front-ends may cache location data if they wish. Such data can go stale without negative consequences: the cost of encountering a stale entry is little more than a cache miss, which involves computing k hash functions and querying k locations.

The popularity of data items can vary dramatically, both spatially (i.e., among data items) and temporally (i.e., over time). Load balancing desirably accommodates such variations and copes with changes in system configuration (e.g., due to server failures or server additions). Depending on the particular system configuration, one or more resources on servers could become the bottleneck, causing client requests to queue up.

In cases where the network on a server becomes a bottleneck, it is desirable to have the request load evenly distributed among all servers in the system. Having r replicas to choose from can greatly mitigate such imbalance. In cases where the disk becomes the bottleneck, server-side caching is beneficial, and it becomes desirable not to unnecessarily duplicate items in the server caches.

Instead of using locality-aware request distribution, for a request on a given data item d, a front-end may pick the least loaded server among those storing a replica of d. Placement of data items and their replicas influences the performance of load balancing in a fundamental way—a server can serve requests on a data item only if it stores a replica of that data item. Due to the use of independent hash functions, data items on a particular server are likely to have their replicas dispersed on many different servers. Thus, such dispersed or diffuse replica placement makes it easier to find a lightly loaded server to take load of an overloaded server.

Re-balancing after reconfiguration may be performed, in which data items may be moved from one server to another to achieve a more desirable configuration. For example, a data item may be moved from a server to a less heavily loaded server. Re-balancing may be performed when a predetermined condition is met (e.g., when a new data item is received, at a particular time, when the average load reaches a certain threshold).

A flow diagram of an example method of balancing network bandwidth during the creation or writing of a received data item on a number of servers is described with respect to FIG. 9. At step 900, a data item is received. A number k of potential servers on which to place the data are determined, at step 905, using k hash functions. A subset of the servers (e.g., a number r) are determined from the k potential servers, at step 910, by looking for the r servers with least combined network and storage load. For example, if Ni is the number of bytes of data currently queued up to be written to server i and Si is the number of bytes of spare capacity in server i, then a server with load <Ni, Si> is picked over a server with load <Nj, Sj> when <Ni <=Nj and Si>Sj>. In other words, the servers are sorted based on the above relationship and the minimum r is picked from the sorted list. At step 915, a copy of the data item is created on the chosen r nodes with version number 0.

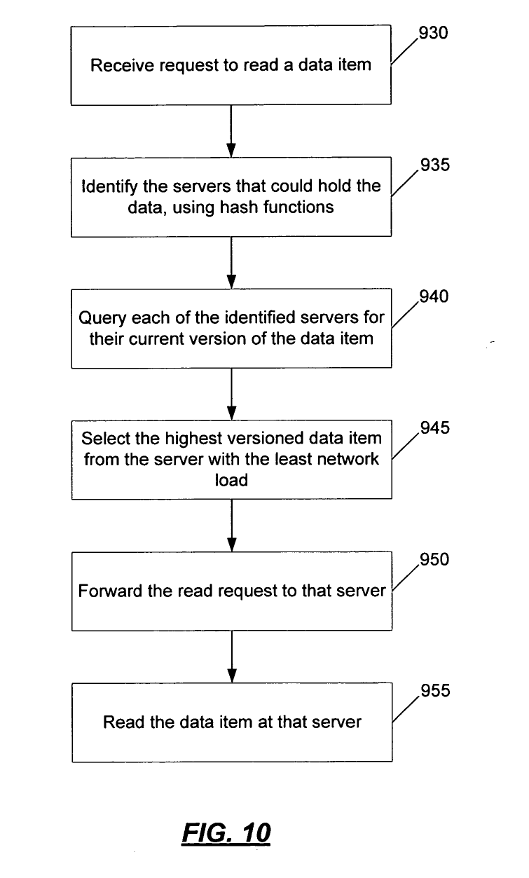

A flow diagram of an example method of reading a data item, while maintaining network bandwith balancing, is described with respect to FIG. 10. At step 930, a read request for a data item is received. At step 935, k hash functions are used to determine the k potential servers that could hold the data. Each server is queried, at step 940, for the current version of data item they hold. Among the servers with highest versioned data item (there should be r of those in the absence of failures), a server is picked with the least network load Ni, at step 945. The read request is forwarded to that server at step 950, which then reads and returns the data item at step 955.

To read a data item, the front-end must first identify the highest version stored by polling at least k-r+1 of the hash locations. This ensures an intersection with a hash location that receives the last completed version.

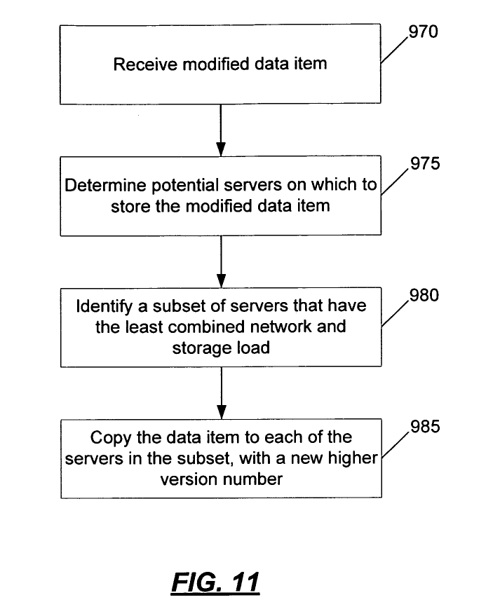

A flow diagram of an example method of balancing network bandwidth during the updating of a received data item on a number of servers is described with respect to FIG. 11. At step 970, a modified data item is received. A number k of potential servers on which to place the data are determined, at step 975, using k hash functions. A number of servers r are determined from the k potential servers, at step 980, by looking for the r servers with least combined network and storage load. Similar to the creating described with respect to FIG. 9, if Ni is the number of bytes of data currently queued up to be written to server i and Si is the number of bytes of spare capacity in server i, then a server with load <Ni, Si> is picked over a server with load <Nj, Sj> if (Ni <Nj) or (Ni=Nj and Si>Sj). The servers are sorted based on the above relationship and the minimum r is picked from the sorted list. At step 985, a copy of the data item is created on the chosen r nodes with a new, higher version number than the current one.

An update creates a new version of the same data item, which is inserted into the distributed storage system as a new data item. Although the new version has the same hash locations to choose from, it might end up being stored on a different subset from the old one based on the current storage utilization on those servers. Depending on the needs of the application, the storage system can choose to delete the old versions when appropriate.

### Exemplary Computing Arrangement

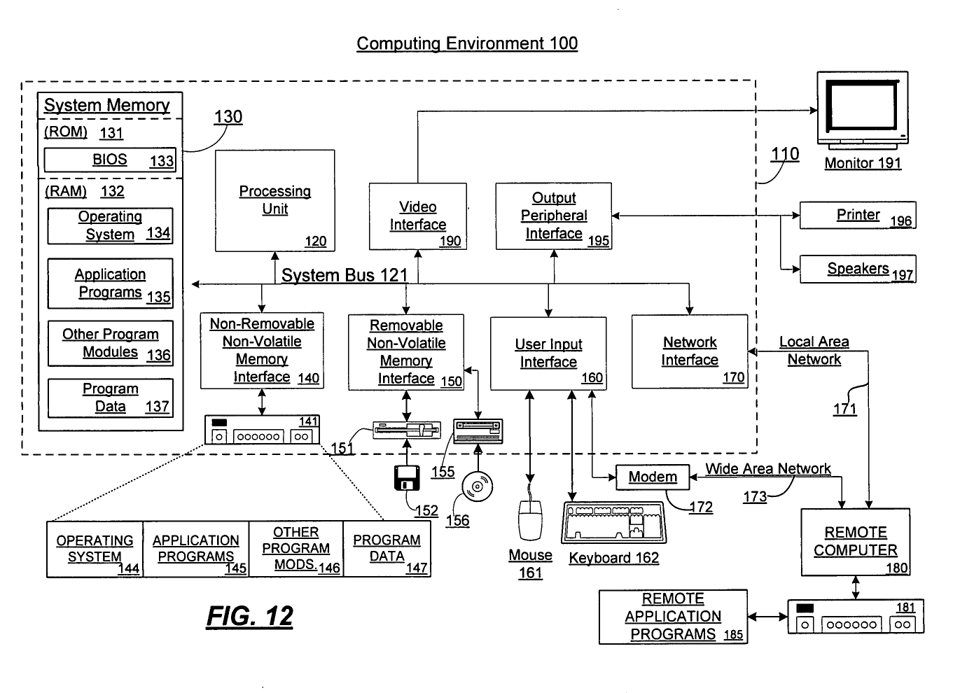

FIG. 12 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 12, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 12 illustrates operating system 134, application programs 135, other program modules 136, and program data 137.

The computer 110 may also include other removable/non-removable, volatile/nonvolatile computer storage media. By way of example only, FIG. 12 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 12, provide storage of computer readable instructions, data structures, program modules and other data for the computer 110. In FIG. 12, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 12. The logical connections depicted in FIG. 12 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 12 illustrates remote application programs 185 as residing on memory device 181. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A data and replica placement method for a data store comprising a plurality of computing devices, comprising:
dividing the computing devices into a number of groups corresponding to a first number, and maintaining a first number of hash functions and a second number corresponding to a replication factor, where the second number is less than the first number;
hashing a data item to a number of locations in the data store among the plurality of computing devices, the number of locations based on the first number; and
storing the data item on a number of the computing devices, the number of computing devices based on the second number.

2. The method of claim 1, wherein the computing devices are servers, and dividing the computing devices into the number of groups comprises partitioning the plurality of servers into the first number of disjoint servers of approximately equal size.

3. The method of claim 2, wherein storing the data item comprises determining the second number of disjoint servers having the least amount of data among the first number of disjoint servers and storing the data item on the second number of disjoint servers.

4. The method of claim 1, wherein the first number of hash functions is based on a level of redundancy and replication.

5. The method of claim 1, further comprising receiving the data item for storage in the data store, prior to hashing the data item.

6. The method of claim 1, further comprising determining the least utilized computing devices.

7. The method of claim 6, wherein the number of the computing devices on which the data item is stored corresponds to the least utilized computing devices.

8. The method of claim 6, wherein determining the least utilized computing devices comprises determining the computing devices with the most spare storage capacity.

9. The method of claim 1, further comprising reading the data item from the computing device on which it is stored that has the least network load.

10. The method of claim 1, further comprising updating the data item on the number of computing devices along with an updated version number.

11. A data and replica placement method for a data store, comprising:
hashing a data item to a number of locations in the data store among a plurality of computing devices, the number of locations based on a first number;
storing the data item on a number of the computing devices, the number of computing devices based on a second number, where the second number is less than the first number; and
updating or modifying the data item on the number of computing devices.

12. The method of claim 11, further comprising dividing the computing devices into a number of groups corresponding to the first number, and wherein the second number corresponds to a replication factor.

13. The method of claim 11, wherein updating or modifying the data item on the number of computing devices includes providing an updated version number.

14. A data and replica placement method for a data store comprising a plurality of computing devices, comprising:
storing a data item on a number of the computing devices;
detecting a failure of one of the computing devices on which the data item is stored;
determining an unused storage location on another of the computing devices outside of the number of computing devices on which the data item is stored; and
copying the data item from one of the computing devices on which the data item is stored to the unused location.

15. The method of claim 14, wherein the number of computing devices on which the data item is stored is based on a replication factor r, r being less than a number of possible locations k in the plurality of computing devices in which the data item may be stored.

16. The method of claim 15, wherein storing the data item comprises:
parameterizing the data store by a k number of hash functions;
hashing the data item to the k possible locations; and
storing the data item on an r number of computing devices of the k possible locations.

17. The method of claim 16, wherein the r number of the computing devices on which the data item is stored corresponds to the least utilized r computing devices.

18. The method of claim 17, further comprising determining the least utilized computing devices by determining the computing devices with the most spare storage capacity.

19. The method of claim 14, wherein copying the data item comprises identifying a copy of the data item on one of the number of the computing devices that has not failed.
